(19) United States
(12) Patent Application Publication
(10) Pub. No.: US 2001/0013548 A1
(43) Pub. Date: Aug. 16, 2001

(54) Input device

(75) Inventor: Ulrich Buschmann, Elchingen (DE)

Correspondence Address: PERMAN & GREEN, 425 POST ROAD, FAIRFIELD, CT, 06430, US

(73) Assignee: Nokia Mobile Phones Ltd.

(21) Appl. No.: 09/749,371

(22) Filed: Dec. 21, 2000

(30) Foreign Application Priority Data
Dec. 28, 1999 (DE) 19963404.1

(51) Int. Cl. G06K 7/00

(52) U.S. Cl. 235/439

(57) ABSTRACT

The invention relates to the design of input devices for objects, in particular of those input devices that at least partially push the object 13.1 out of the device. A feature common to all these input devices is that they are equipped with a slot 12.1 having an insertion aperture 11.1 to insert objects 13.1 and an ejection device equipped with a first energy storage device 33 that pushes an object 13.1 inserted in the slot 12.1 out of the insertion aperture 13.1 for removal. As many of the known input devices are very complex, it is suggested according to the invention that there is a movable cradle 30 in slot 12.1 connected to the first energy storage device 33 that can be moved in the direction of insertion and ejection P2, P3 of the corresponding object 13.1, and that the cradle 30 is connected to the closing device 24 by components that mesh with each other that are at least partially secured when the cradle 30 is in the position Pos.2.

### FIELD OF THE INVENTION

The invention relates to the design of input devices for objects, in particular of those input devices that at least partially push the object out of the device while the corresponding object is being removed.

### BACKGROUND OF THE INVENTION

Input devices of this type are common in the background of the invention and well known so that we do not need to go into more detail here. Representative of input devices of this type are the input devices of video and cassette players. These input devices are characterized in that there is a slot with an insertion aperture and a closing device that blocks the insertion aperture when an object is inserted in the slot. In order for the cassette to assume a defined position in the video or cassette recorder, there is a complex mechanism that generally moves the cassette perpendicular to the direction of insertion after it has been inserted in the slot. Similar to these input devices are those input devices in which the components that interact with the objects inserted in the slot are moved towards the object by a corresponding, mechanism when the object has reached its end position in the slot.

As can easily be realized, all input devices named are very complex as they need to not only ensure that the object comes in contact with the corresponding components, but they also need to ensure that the object is separated from the corresponding components.

In addition, there are known input devices in which the corresponding object reaches its end position in the slot solely through the insertion motion. Examples of such are the telephone cards used in public telephone booths in which the telephone card only needs to be inserted in the insertion aperture of the slot to reach its operating position. The input devices in automated teller machines (ATMs) also operate in a similar manner because in these machines the ATM card is not moved perpendicular to the direction of insertion in order to achieve its operating position. Even when the input devices stated in this paragraph can have a much simpler design than the input devices stated in the previous paragraph, components must also be provided here that ensure that the object can be removed from the slot after the operating state has terminated. Ejection devices are frequently provided for these input devices that push the object out with the aid of a motor. This mode of operation is known from ATMs, for example. In addition to the motorized and therefore complex input devices, there are also input devices known in which the objects load a spring during insertion that, when the object is to be removed from the input device, supplies the energy required to eject the object. The input devices for cards in public telephone booths belong to this type of input device, for example, because in these input devices the card is ejected using the energy stored during insertion when the telephone call is completed or when an ejection button is pressed. However, the fact that large and heavy objects must also load the spring in these input devices during insertion, thereby increasing the force needed for insertion, is considered to be a disadvantage. This problem can be ignored for small and light objects. However, one problem arises for small and light objects, namely that the spring also attempts to push the object out of the slot during the insertion motion so that when the user suddenly releases the object during the insertion of the object, the object is completely ejected from the slot and may be damaged or lost when it falls out.

For this reason the invention is the result of the task of specifying an input device of the last type named that makes it unnecessary to load an energy storage device during the insertion motion.

### SUMMARY OF THE INVENTION

This task will be accomplished using the features specified in claim 1. Advantageous extensions and expansions of the invention can be obtained in the claims thereafter.

If the input device is designed in accordance with claim 1, then the corresponding object can be inserted into the slot without applying force, i e. without simultaneously loading the energy storage device responsible for ejecting the object later on. This is due to the fact that the cradle is moved to its secured position Pos.2 when the closing device is opened due to the connection of the cradle to the closing device, and the energy storage device therefore cannot provide any resistance to an insertion motion due to its connection to the cradle.

An especially simple implementation results when the input device is designed according to claim 2.

If in accordance with claim 3 the closing device is equipped with a second energy storage device, then this energy storage device can be used to automatically close the closing device.

The combination of features according to claim 4 ensure that the closing device will only close automatically when an object is removed from the slot and will only be secured when an object is to be inserted in the slot. The latter is then especially advantageous because a second hand is not required to insert the object. At the same time, after the object has been inserted the closing motion of the closing device is aided by the energy stored in the energy storage device.

If the closing device is designed in accordance with FIG. 5, then the closing device can only be closed when the object has reached its end position in the slot. In addition, the fact that the object inserted in the slot is flush with the insertion aperture ensures that the end position of the object in the slot does not change when the closing device is closed.

### BRIEF DESCRIPTION OF THE DRAWINGS

The following figures contain the following:

FIG. 1 A side view of an input device;

FIG. 2 Bottom view of a cradle,

FIG. 3 Another diagram according to FIG. 2;

FIG. 4 Another diagram according to FIG. 3;

FIG. 5 Another diagram according to FIG. 4;

FIG. 6a-c Three diagrams of two fixed ramps and FIG. 7a-e Five schematic diagrams of a cradle with cover.

### DETAILED DESCRIPTION OF THE PREFERRED EMBODIMENTS OF THE INVENTION

The input device according to the invention will be explained in more detail based on the figures.

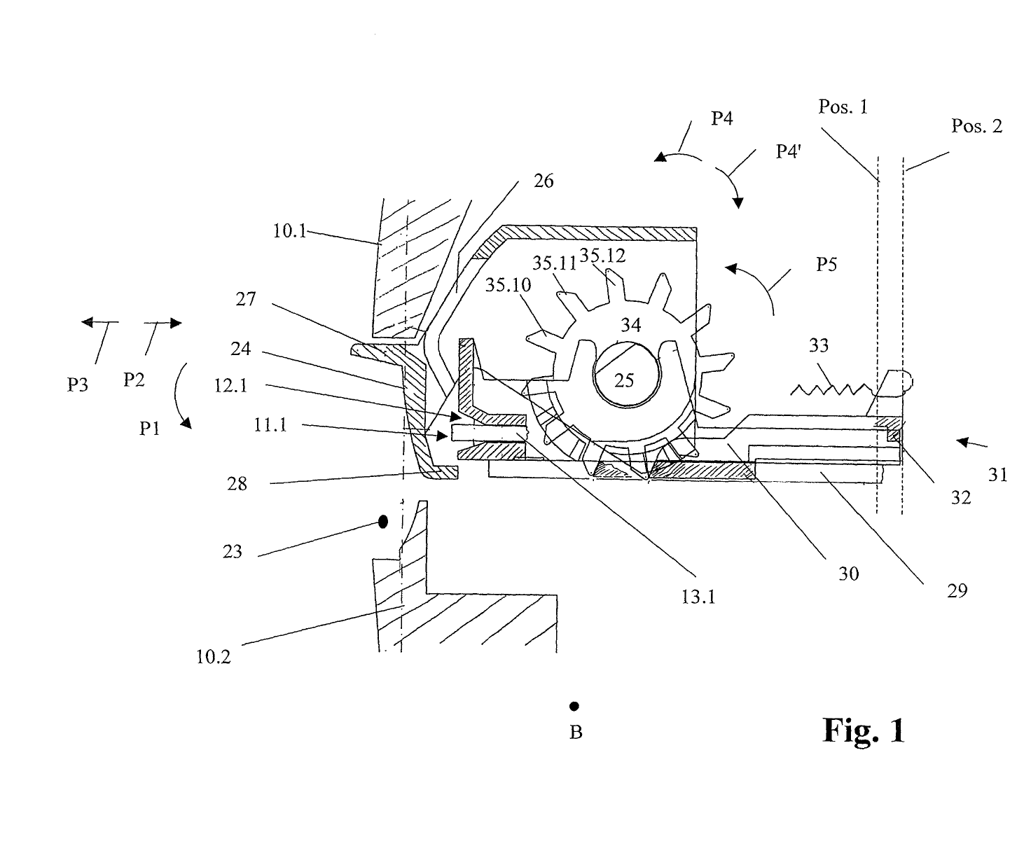

FIG. 1 shows a mechanical implementation of an input device according to the invention.

This cross-sectional diagram shows a housing shell 10.1, 10.2 that is equipped with an opening 23. The slot 12.1 is located behind the opening 23 (in the interior of the housing), whereby the slot 12.1 contains an object in the form of a card 13.1. For the sake of clarity, FIG. 1 does not contain representations of the spring contacts within the slot 12.1 or of the memory and/or electrically conducting contact surfaces in or on the card.

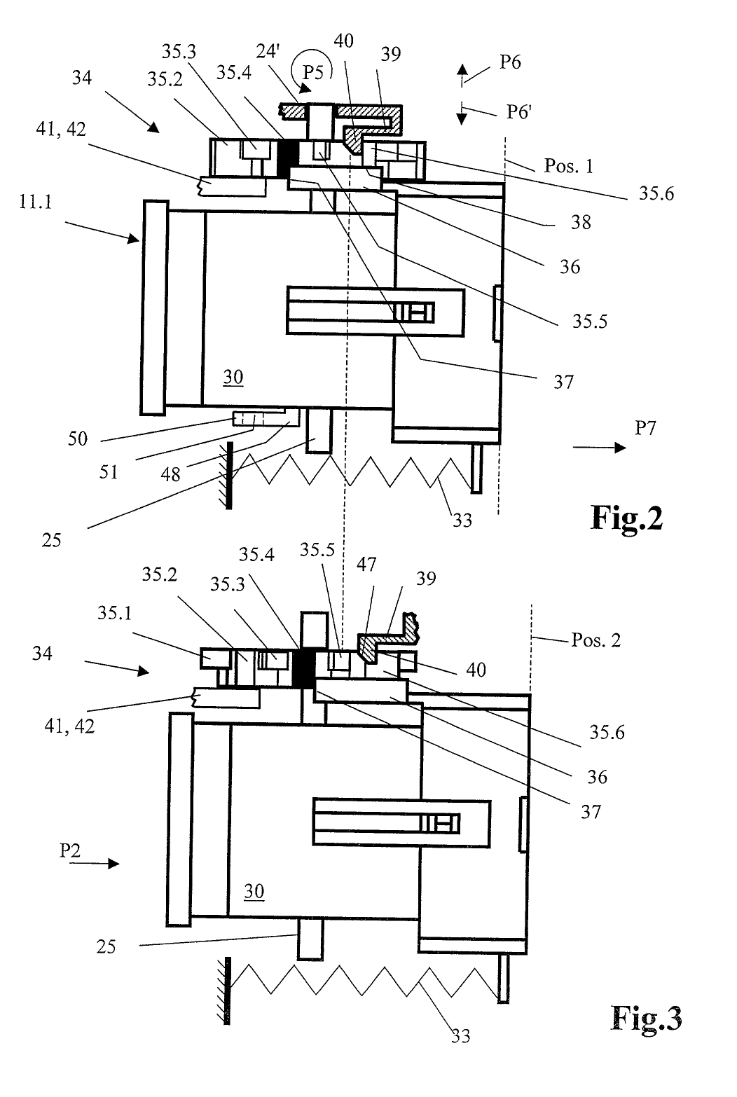

In addition, FIG. 1 also shows a closing device. This closing device is formed mainly by a cover 24 whose side panels 24′ are mounted on a shaft 25 and that can be rotated in the direction of the arrow P4, P4′ (see also FIG. 2 for their mounting position) The cover 24 also has a cut-out 26 and a handle 27. If, as shown in FIG. 1, the card 13.2 is inserted in slot 12.2 and the handle 27 is seated against the housing shell 10 1, then the cover 24 blocks the opening 23 and the insertion aperture 11.1 of the slot 12.1.

If a card 13.1 is to be removed from the slot 12.1 containing the card 13.1, then, based on the starting position shown in FIG. 1, the cover 24 must be moved downwards in the direction of the arrow P1 (P4) until the handle 27 is seated against the housing shell 10.2. If the handle 27 has made contact with the housing shell 10.2, then the cut-out 26 in the cover 24 allows access to the insertion aperture 11.1 and the card 13.1 can be removed from the slot 12.1 (see also FIG. 7e).

The following contains a detailed description of an ejection device for a card 13.1 located in slot 12.1.

As can be seen in FIG. 1, the slot 12.1 is formed by a fixed surface 29 and a cradle 30 for this purpose. The cradle 30 is connected to the fixed surface 29 and can be slid in the direction of ejection and of insertion (P2, P3) of the card 13.1. There is also a stop 32 at the end 31 of the cradle 30 that is seated against the card 13.1 inserted in slot 12.1 when it has reached its end position in slot 12.1. In addition there is a mechanical energy storage device in the form of a spring 33 located between the cradle 30 and the fixed surface (not shown in its entirety in FIG. 1). Finally, there is a gear 34 on shaft 25 that, together with the shaft 25, can only be rotated in a counterclockwise direction P5.

We would like to point out at this point that the teeth 35 of the gear 34 that have an even-numbered ordinal number (35.2, 35.4, 35.6, . . . ) are wider in the direction the shaft axis than the teeth 35 that have an odd-numbered ordinal number (35.1, 35.3, 35.5, . . . ) and that there is a tooth 35 with an odd-numbered ordinal number (35.1, 35.3, 35.5, . . . ) located between each pair of teeth 35 with an even-numbered ordinal number (35.2, 35.4, 36.6, . . . ).

It can clearly be seen in FIGS. 2 through 5, which all show a bottom view of the cradle 30 when looking up from point B in FIG. 1, that the gear 34 is located on the side next to the cradle 30, that the teeth 35 with odd-numbered ordinal numbers (35.1, 35.3, 35.5, . . . ) are not as wide (in the direction of the cradle 30) as the teeth 34 with even-numbered ordinal numbers (35.2, 35.4, 35.6, . . . ) and that there is a cam 36 on the cradle 30 that extends in the direction of the gear 34 whose front edge 37 is designed to make physical contact with the teeth 35 with even-numbered ordinal numbers (35.2, 35.4, 36.6, . . . ) and whose longitudinal edge 38 always remains a short distance from the teeth 35 with odd-numbered ordinal numbers (35.1, 35.3, 35.5, . . . ).

FIG. 2 shows a state in which the cover 24 is closed (as shown in FIG. 1) and in which the slot 12.1 does not contain a card 13.1. In this state the insertion aperture 11.1 is in the position Pos.1, which is not only shown in FIG. 2 as a dotted line but is also shown as such in FIGS. 1 and 5. In addition, it can be seen in the diagram in FIG. 2 that there is a tongue 39 on the cover 24, on the end of which there is a lug 40 that extends into the space between two teeth 35 (35.5, 35.6) of gear 34.

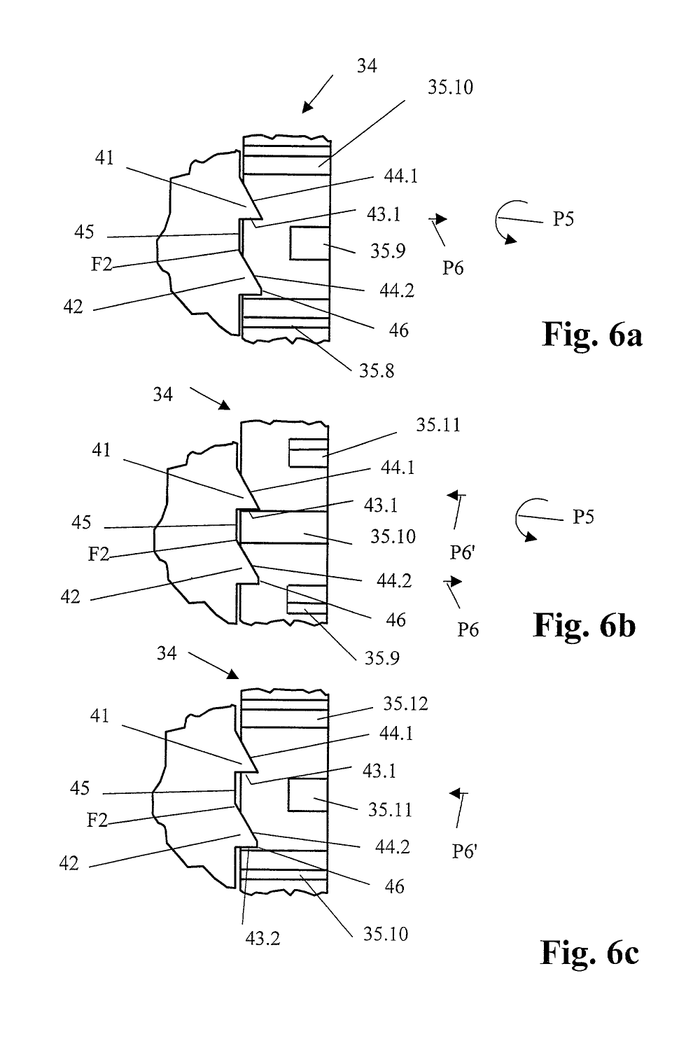

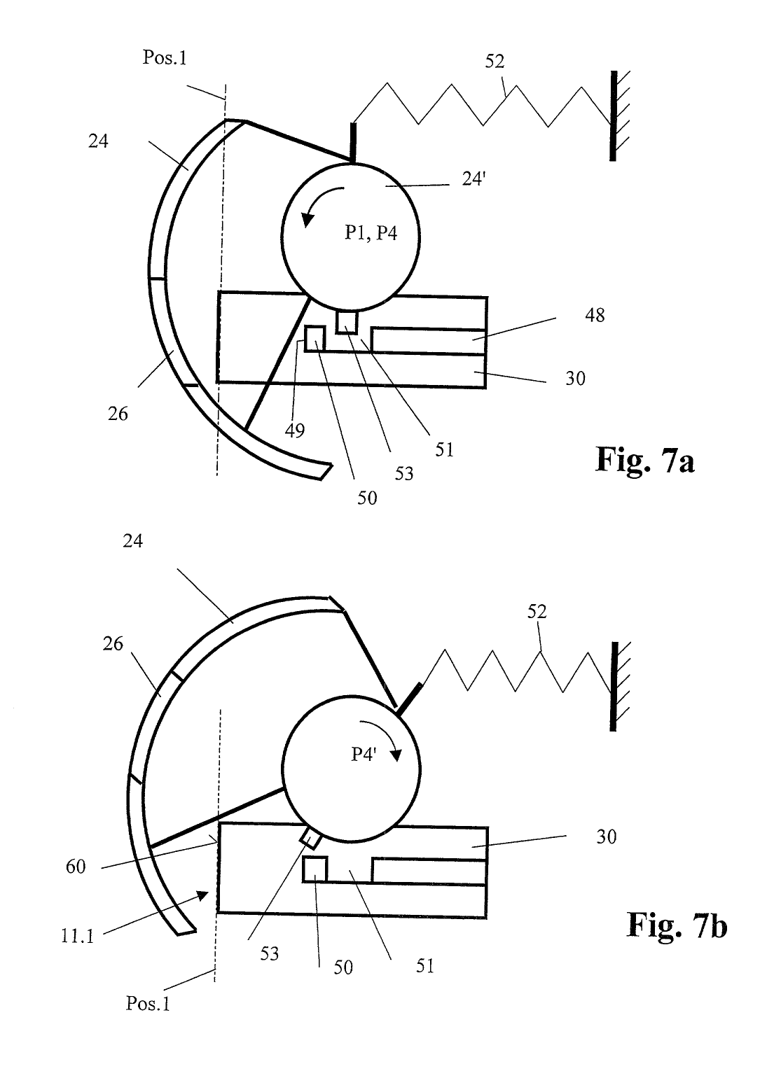

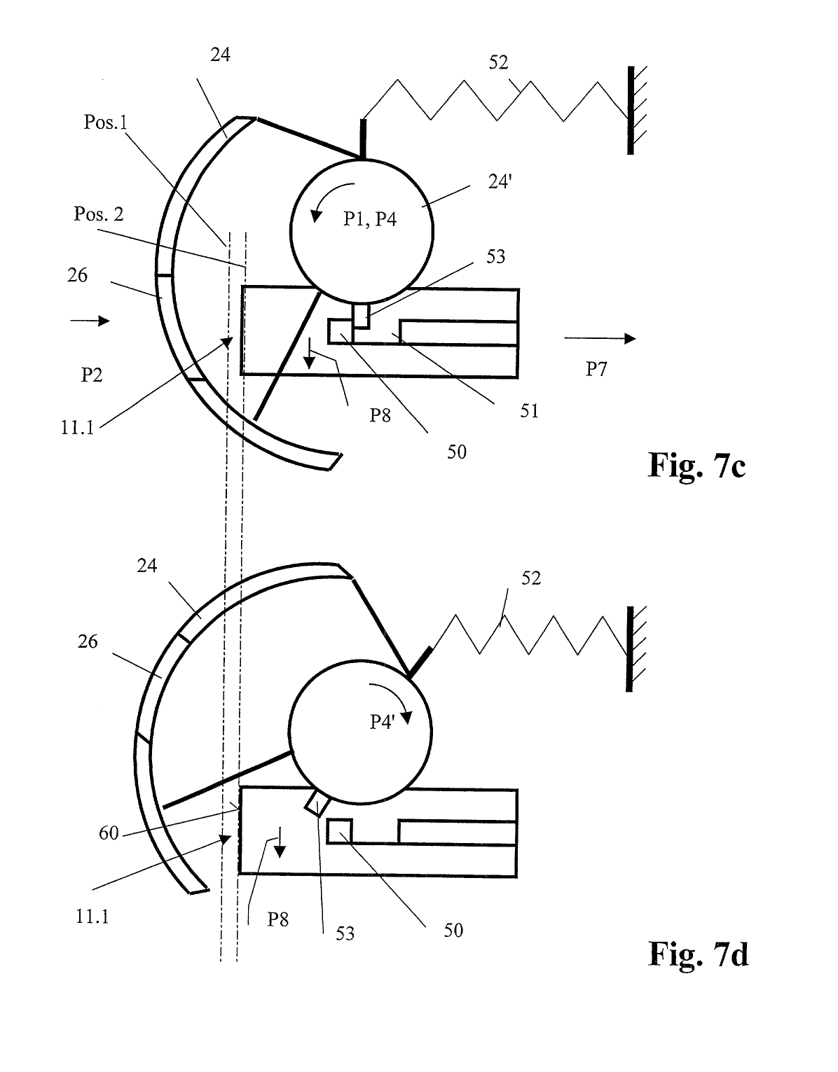

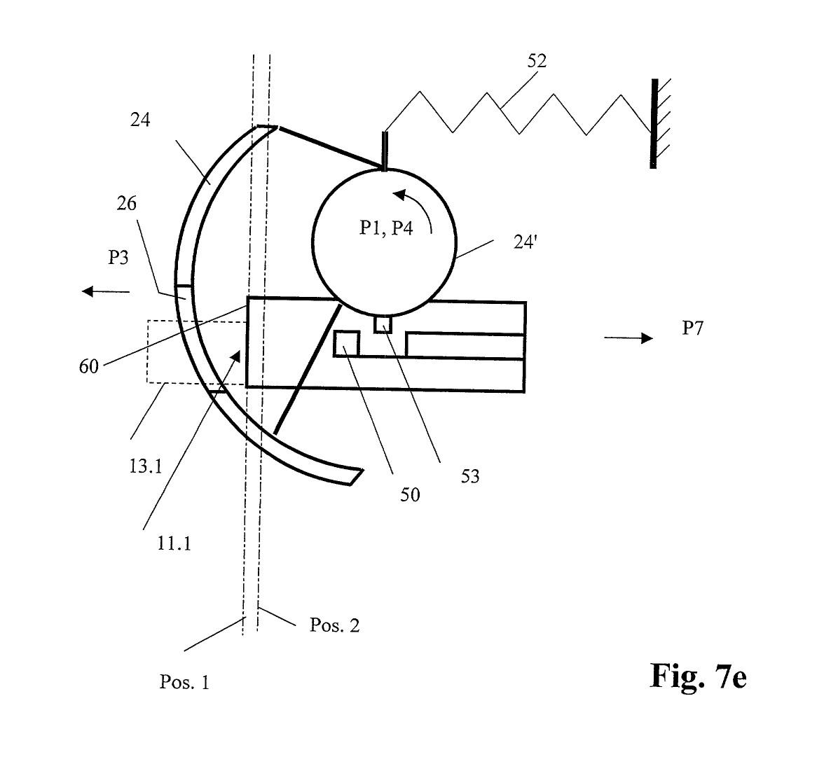

There are also two fixed ramps 41, 42 located on the side of the gear 34 that faces the cradle 30. The ramps are only shown schematically in FIGS. 2 through 5 and in will be described in more detail in the context of FIG. 6a through c. The diagram in FIG. 6a refers to the situation that is also shown in FIG. 2. It can clearly be seen in the diagram according to FIG. 6a that there are two ramps 41, 42 arranged one behind the other in the direction of rotation P5 of the shaft 25, whereby the steep falling edge 43.1 of ramp 41 and the base point F2 of the incline 44.2 of ramp 42 are separated by an intermediate area 45. It can also be seen in FIGS. 6a through c that the ramp 42 has a flat area 46 that primarily runs parallel to the intermediate area 45.

If the situation shown in FIG. 2 arises, then, as shown FIG. 6a, the two ramps 41, 42 lie exactly between two even-numbered teeth 35.8, 35.10 of gear 34, while the odd-numbered tooth 35.9 located between the two even-numbered teeth 35.8, 35.10 is located directly across from the intermediate area 45.

If, based on the situation shown in FIG. 2, the cover 24 is now opened in the direction corresponding to the direction of the arrows P1, P4 shown in FIG. 1, then this opening motion will be transferred to the lug 40. However, as the right side of lug 40 (as shown in FIG. 2) is seated against a tooth 35 with an even-numbered ordinal number 35.6 at this time, the opening motion will be transferred to the gear 35, rotating the gear together with the shaft 25 in the direction of the arrow P5 until the gear 34 reaches the position shown in FIG. 3.

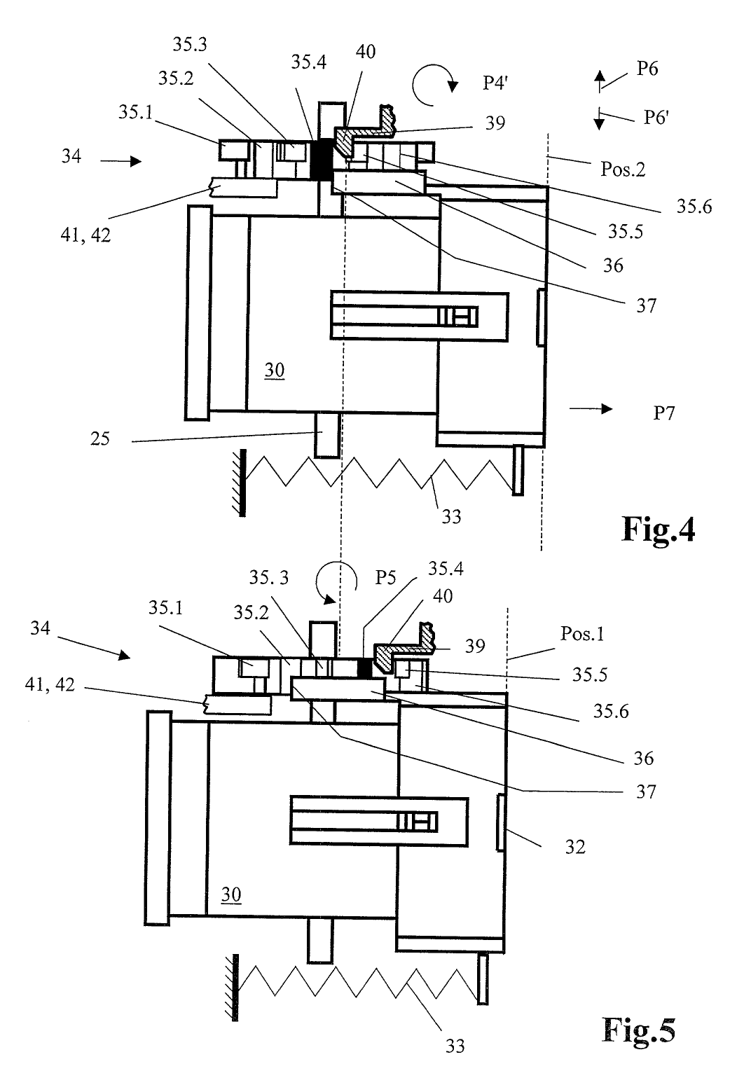

At the same time the gear 34 is rotating, the even-numbered tooth 35.4 (which is shown entirely in black in FIGS. 2 through 5 to improve recognition of the tooth) makes contact with the front edge 37 of the cam 36 and pushes the cam 36 together with the cradle 30 in the direction P7 to the position designated in FIG. 4 by Pos.2. The spring 33 is loaded while the cradle 30 moves from Pos.1 to Pos.2.

In addition, the shaft 25 and the gear 34 can be moved in the direction (P6, P6′) of the shaft axis. The mobility of the gear 34 and the shaft 25 ensures that the rotation P5 of the gear 34 is not impeded by the ramps 41, 42, and, based on the position shown in FIG. 6a, that the even-numbered tooth 35.10 of the gear 34 can slide along the incline 44.1 of ramp 41 when the gear 34 and the shaft 25 are moved in the direction P6 at the same time. At the same time the rotational motion P5 ends, the even-numbered tooth 35.10 of gear 34 meshes with the intermediate area 45 while the motion of the gear 34 and the shaft 25 in the direction P6′ is being completed so that the even-numbered tooth is then seated against the steep falling edge 43.1 of ramp 41 with one of its sides (FIG. 6b). The meshing of the tooth with the intermediate area 45 is aided in that the motion of the gear 34 and the shaft 25 in the direction P6 of the shaft axis is performed while working against a spring force during the sliding phase of the even-numbered tooth 35.10 along the incline 44.1. This spring force is provided by the tongue 39 (FIG. 2) in our example, which is also bent back in the direction P6 of the shaft axis as the even-numbered tooth slides along the incline 44.1.

If a situation in accordance with FIGS. 3 and 6b arises after the cover 24 has been opened (FIGS. 1 and 2), then the spring 33 is loaded and the cradle 30 moves to its position Pos.2. In addition, the even-numbered tooth 35.4, which is shown in black FIGS. 2 through 5 to improve its visibility in the diagrams and which has moved the cam 36 and the cradle 30 to the position Pos.2 due to the rotation P5, is vertical after the rotation P5 (FIG. 3) Even when the spring 33 is loaded in the position Pos.2, there is no danger that the gear 34 will rotate in the opposite direction of rotation P5 after the cover 24 has been completely opened (FIG. 1) as no force acts in the direction of the arrow P1. This is due to the fact that when the cover 24 has been completely opened, thereby rotating the gear 34, the even-numbered tooth 35.10 is guided over the ramp 41 and once the opening motion has been completed one of its sides is seated against the steep falling edge 43.1 of ramp 41, which prevents the rotation against the direction of rotation P5 (FIG. 6b).

When the position Pos.1 is reached as shown in FIG. 3, then a card 13.1 can be inserted in the slot 12.1 through the cut-out 26 in the cover 24 (FIG. 1). The insertion of a card is indicated in FIG. 3 by the arrow P2. If the card 13.1 inserted in the slot 12.1 makes physical contact with the stop 32, then it has reached its end position in the slot 12.1 (FIG. 1) and the cover 24 can be closed again. To improve understanding we would like to point out in this context that the card 13.1 reaches its end position when inserted without any addition motion of the cradle 30, etc., for example. This prevents damage to the card 13.1 that can otherwise occur very easily when additional motions must be performed after the object or card 13.1 has been inserted in the slot 13.1. The cover 24 is closed by moving the handle 27 upwards in the opposite direction of the arrow P1 until it makes contact again with the housing shell 10.1. The tongue 39, together with the lug 40, are rotated in the opposite direction of the arrow P5 when the closing motion is carried out (FIG. 4). This relationship is indicated in FIG. 1 by the arrow P4′.

As already explained in the context of FIGS. 6a and b, because the tongue 39 can move in the direction P6 and the lug 40 also has a bevel 47 on the side facing away from the direction of rotation P5 of gear 34, the bevel 47 comes into physical contact with an odd-numbered tooth 35.5 (FIG. 3) of the gear 34 during the closing motion, thereby bending the tongue 39 slightly in the direction P6 due to the resulting sliding of the tooth along the bevel 47. At the same time as the closing motion is completed, the lug 40 snaps into place in a space between an even-numbered tooth 35.4 and an odd-numbered tooth 35.5 of the gear 34, whereby the side of the lug 40 on which the bevel 47 is located faces the tooth 35 with the even-numbered ordinal number 35.4. This relationship is shown in detail in FIG. 4.

If the card 13.1 inserted in slot 12.1 is now to be removed, the user only needs to open the cover 24 in the direction of the arrow P1 (FIG. 1).

If the renewed opening motion is performed in the direction of the arrow P1; P4, then this motion is transferred again via the tongue 39 and the lug 40 to the gear 34 and the shaft 25, where, based on FIG. 4, the latter two components 25, 34 rotate in the direction of the arrow P5. The cam 36, together with the cradle 30, are also moved slightly in the direction of the arrow P7 by the new rotation P5 of the shaft 25 and the gear 34 due to the physical contact existing between the even-numbered tooth 35.4 (shown in black to improve the clarity of the diagram) of gear 34 and the front edge 37 of the cam 36. In this respect the same basic principles also apply here that were discussed above in the context of FIG. 2. As the situation shown in FIG. 6b has not changed after reaching the position shown in FIG. 4, the even-numbered tooth 35.10 located in the intermediate area 45 as shown in FIG. 6b slides over the incline 44.2 of ramp 42 due to the renewed opening motion P1 and the resulting rotation of the gear 34 in the direction of the arrow P5. The gear 34 and the shaft 25 are moved slightly in the direction P6 at the same time as the face of the even-numbered tooth 35.10 slides along the incline 44.2. At some point in time the even-numbered gear 35.4 (shown in black to improve the clarity of the diagram) will not be in physical contact with the cam 36 anymore due to the renewed opening motion P1 and due to the motions in the direction P6 and P7. This state is primarily reached when, based on FIG. 6b, the front of the even-numbered gear 35.10 has reached the flat area 46 present on the ramp 42 due to the rotation P5. This lack of physical contact between the cam 36 and even-numbered gear 35.4 (shown in black to improve the clarity of the diagram) allows the spring 33 to contract again, which simultaneously moves the cradle 30 in the opposite direction of the arrow P7 back to the position Pos.1 shown in FIG. 5. Because a card 13.1 located in the slot 12.1 is seated against the stop 32 of the cradle 30 (FIG. 1) when the cradle 30 is in the position Pos.2, moving the cradle 30 to the position Pos.1 will push the inserted card 13.1 a little bit out of the insertion aperture 11.1, where it can be easily grabbed to remove it completely.

Just for the sake of completeness we would like to point out that once the position Pos.1 shown in FIG. 5 has been reached, the even-numbered tooth 35.10, which was located between the two ramps 41, 42 before the renewed opening motion P1 was performed (see FIG. 6b), is pressed again in the direction P6′ after passing over the flat area 46 due to the spring action of the tongue 39 already explained above so that a situation arises at the end the rotational motion P5 that corresponds to the situation shown in FIG. 6c.

If the card 13.1 has been completely removed, then the resulting state corresponds to that shown in FIG. 2 when the cover 24 is closed again by a closing motion in the opposite direction of the arrow P1 (FIG. 1) or by a rotation P4′ corresponding to the explanation stated in the context of FIG. 5. However, the lug 40 snaps into place in the space between the even-numbered tooth 35.4 and the odd-numbered tooth 35.3 of gear 35 after the rotational motion P4′ has been completed.

The opening and closing of the cover 24 will be explained in more detail in the following.

The cradle 30 is equipped with a sliding tongue 48 (which is only shown in FIG. 2 to improve the clarity of the diagrams in FIGS. 2 through 5) to make it easier to close the cover 24. This sliding tongue 48 has a hook 50 and a pocket 51 on its free end 49 (FIGS. 7a through 7e). In addition, the cover 24 and the side panels 24′ can be seen in the schematic diagrams the FIGS. 7a through 7e.

In the situation shown in FIG. 7a the cradle 30 is located in the position Pos.1, which is also shown in FIG. 2. Additionally, the cover 24 has been opened by a motion P1, P4. The latter is indicated in that the cut-out 26 of the cover 24 is in front of the cradle 30, thereby allowing access to the insertion aperture 11.1. The spring 52 that forms a second energy storage device is connected to the cover 24 and has also been loaded by the opening motion P1, P4. If no more of the force used to trigger the opening motion P1, P4 is applied, then the cover 24 a rotates in the direction P4′ (FIG. 7b), whereby the energy for the rotational motion in the direction P4′ is supplied by the spring 52 just loaded. It can clearly be seen in the diagram shown in FIG. 7b that the cover 24 blocks the insertion aperture 11.1 again after the rotational motion in the direction P4′ has been completed because the cut-out 26 has now been rotated upwards.

As can be seen in FIGS. 7a through 7e, there is a pin 53 on the side panel 24′ of the cover 24 that projects slightly into in the pocket 51 when in the position shown in FIG. 7a. As the diagrams in FIGS. 7a through 7e clearly show that the pocket 51 is wider than the pin 53, then the rotational motion P4′ induced by the spring 52 will not be hindered by the hook 50 when the cradle 30 is located in the position Pos.1 when no more force is applied in the direction P1, P4.

Based on FIG. 7b, if the cover 24 is opened again to insert a card 13.1 (not shown in FIG. 7b) by moving it in the direction P1, P4 and the cut-out 26 is rotated until it is in front of the insertion aperture 11.1, then, as already explained in the context of FIGS. 2 and 3, the cradle 30 is moved in the direction P7 to its position Pos.2. While the cradle 30 is in motion, pin 53 moves in the direction of the arrow P1, P4. However, as the cradle 30 moves away from pin 53 while being moved to the position Pos.2, pin 53 cannot take its position within the pocket 51 without meeting resistance. To be more precise, when the pin 53 makes contact with the hook 50 that prevents free motion during the rotational motion P1, P4 and the motion of the cradle 30 in the direction P7, the hook 50 is pushed away by pin 53 in the direction P8. If the rotational motion P1, P4 is complete, the spring 52 is loaded and the cover 24 is open, then the pin 53 is seated against the hook 50 as shown in FIG. 7c, whereby a rotational motion in the opposite direction of the arrow P1 or in the direction of the arrow P4′ is prevented in spite of the force exerted by the loaded spring 52. This state can be used to insert a card 13.1 (not shown in FIG. 7c) in the insertion aperture 11.1 (indicated by the arrow P2).

If the card 13.1 is inserted in the direction P2, then the cover 24 can be closed by moving it in the direction P4′, whereby the course of events already explained in the context of FIG. 4 is takes place at the same time. As a closing motion P4′ performed in accordance with FIG. 7c does not lead to any change in the position of the cradle 30, the hook 50 is deflected in the direction P8 by the force of the pin 53 acting in the direction P4′, so that, once the resistance of the hook 51 is overcome by pin 53, the spring 52 finishes the closing motion in the direction P4′. The cover 24 then reaches the position shown in FIG. 7d.

If the cover 24 is now opened again starting at the position shown in FIG. 7d by moving the cover in the direction P1, P4, then, as explained in the context of FIG. 5, the cradle 30 is moved from the position Pos.2 back to Pos.1 and the card 13.1 is pushed out of the insertion aperture 11.1. The unhindered mobility of the cradle 30 required to eject the card 13.1 is not impaired by the pin 53 and the hook 50 as the device is synchronized so that the cam 36 (FIGS. 2 through 5) is not hindered by a tooth 35 with an even-numbered ordinal number 35.4 anymore (see the explanation for FIG. 5) once the pin 53 has already overcome the resistance of the hook 50 during the rotation in the direction P5. If the opening motion in the direction of the arrow P5 has been completed, then the result is the situation shown in FIG. 7e. It can clearly be seen in this diagram that the card 13.1 (indicated in FIG. 7e by the dotted lines) is pushed out of the insertion aperture 11.1 and the cut-out 26 due to the motion of the cradle 30 to the position Pos.1. If the card 13.1 projects out of the cut-out 26 after the opening motion P1, P4 is complete, then a closing motion corresponding to the principles shown in FIG. 7b is prevented in spite of the cradle 30 being in the position shown in FIG. 7a. On the contrary, the closing motion in the direction P4′ (according to FIG. 7b) will only be carried out when the situation shown in FIG. 7a is reached again after reaching the position shown in FIG. 7e and the complete removal of the card 13.1 from the insertion aperture 11.1 and cut-out 26 because the spring 52, which supplied the energy required for the closing motion, can only contract after this point in time.

Just for the sake of completeness we would like to point out that the hook 50 and the pin 53 are shown in FIGS. 7a through 7e for the sake of clarity without the bevels and/or inclines that facilitate proper interaction between them. The cover 24 is not shown in the closed state seated against the panel sections 60 surrounding the insertion aperture 11.1 in FIGS. 7b and 7d solely due to technical drawing reasons. If this is to be implemented to secure the card 13.1, for example, then the panel sections 60 surrounding the insertion aperture 11.1 only need to be modified to match the contour of the cover 24.

1. Input device
with a slot 12.1 having an insertion aperture 11.1 for inserting objects 13.1 and with an ejection device equipped with a first energy storage device 33 that pushes an object 13.1 inserted in the slot 12.1 out of the insertion aperture 13.1 for removal,
characterized in that
there is a closing device 24 on the insertion aperture 11.1,
there is a movable cradle 30 in slot 12.1 connected to the first energy storage device 33 that can be moved in the direction of insertion and ejection P2, P3 of the corresponding object 13.1 and
the cradle 30 is connected to the closing device 24 by components that mesh with each other and are at least partially secured when the cradle 30 is in the position Pos.2.

2. Input device according to claim 1 characterized in that
the ejection device has a first energy storage device 33 and a cradle 30 that moves in the direction of insertion and of ejection P2, P3 of the object 13.1 insertable in slot 12.1,
a gear 34 on a rotatable shaft 25 that can be slid in the direction of the shaft axis and whose teeth 35 with even-numbered ordinal numbers (35.2, 35.4, 35.6, . . . ) are wider in the direction of the shaft axis than the teeth 34 with odd-numbered ordinal numbers (35.1, 35.3, 35.5, . . . ),
a cam 36 connected to the cradle 30 whose front edge 37 makes physical contact with the teeth 35 with even-numbered ordinal numbers (35.2, 35.4, 35.6, . . . ) and whose longitudinal edge 38 maintains a short distance to the teeth 35 with odd-numbered ordinal numbers (35.1, 35.3, 35.5, . . . ),
a tongue 39 connected to the closing device 24 that can be moved not only in the direction of the shaft axis, but also in the direction of rotation of shaft 25, and that has a lug 40 on its free end to mesh in the space between an even and an odd-numbered tooth 35 (35.1, 35.2; 35.2, 35.3) of the gear 34 and two stationary ramps 41, 42 located one behind the other in the direction of rotation of shaft 25 that are periodically in physical contact with the front surface of the teeth 35 with even-numbered ordinal numbers (35.2, 35.4, 35.6, . . . ).

3. Input device according to claim 1 or 2 characterized in that
there is a second energy storage device 52 that is connected to the closing device 52 that, when the closing device 24 is open, contains stored energy.

4. Input device according to claim 3 characterized in that
there is a sliding tongue 48 connected to the cradle 30 that follows the movements of the cradle 30 and whose free end is formed as a movable hook 50 and
that there is a pin 53 on the closing device 24 that, when the closing device 24 is open to insert an object 13.1 in the slot 12.1, is secured by the movable hook 50 to prevent the release of the energy stored in the second energy storage device 52.

5. Input device according to one of claims 1 through 4 characterized in that
the object 13.1 inserted in the slot 12.1 is flush with the insertion aperture 11.1 and
the insertion aperture 11.1 is surrounded by panel sections 60 against which the closing device 24 is seated when it blocks the insertion aperture 11.1.
